(19) United States
(12) Patent Application Publication
(10) Pub. No.: US 2013/0003711 A1
(43) Pub. Date: Jan. 3, 2013

(54) COMMUNICATION SYSTEM, COMMUNICATION APPARATUS, COMMUNICATION CONTROL METHOD, AND COMMUNICATION CONTROL PROGRAM

(76) Inventors: Yoshio Konno, Osaka-shi (JP); Koichi Tsunekawa, Osaka-shi (JP); Toshiaki Kameno, Osaka-shi (JP); Katsutoshi Ishikura, Osaka-shi (JP)

(21) Appl. No.: 13/634,783

(22) PCT Filed: May 10, 2011
(86) PCT No.: PCT/JP2011/060717

§ 371 Date: Sep. 13, 2012

(30) Foreign Application Priority Data
May 11, 2010 (JP) 2010-109241

(51) Int. Cl. H04J 1/00

(52) U.S. Cl. 370/343

(57) ABSTRACT

A CC-ID information storing unit stores CC-ID information, for every frequency band of a monitoring CC, in which frequency band information and CC-ID are associated. A resource information acquiring unit converts CC-ID extracted from control information into frequency band information.

### TECHNICAL FIELD

The present invention relates to a communication system, a communication apparatus, a communication control method, and a communication control program.

This application is based upon and claims the benefit of priority from prior Japanese Patent Application No. 2010-109241, filed May 11, 2010, the entire contents of which are incorporated herein.

### BACKGROUND ART

In 3^{rd} Generation Partnership Project (3GPP), the specification for a current (3G) Long Term Evolution (LTE) communication scheme has been promoted.

In addition, LTE-Advanced (LTE-A) is being studied as the LTE communication scheme. LTE-A is required to implement higher-speed communication than in LTE and support a wider band (a band of up to 100 MHz exceeding a band of 20 MHz of LTE) than in LTE. However, it is difficult to globally secure a continuous frequency region of a wide band for LTE-A. In addition, with the aim of maintaining compatibility with LTE to a maximum extent, career aggregation (CA) technology, which secures a bandwidth of a maximum of 100 MHz and implements high-speed and large-capacity communication by performing communication through the aggregation of a plurality of carriers having a bandwidth of up to 20 MHz, has been proposed and agreed upon at the 3GPP RANI #53b meeting (see Chapter 5 of Non-Patent Document 3).

In the CA technology, a carrier of up to 20 MHz is referred to as a component carrier (CC). Detailed specifications such as signaling, channel arrangement, and mapping are being studied in the CA technology.

CCs for use in communication using the CA technology are defined as a downlink (DL) CC set (DL-CC set) and a monitoring CC set. The DL-CC set is used to be specific to user equipment (UE), and available CCs are designated for every user. In addition, the monitoring CC set is CCs to be used for a control channel of scheduling or the like among DL-CC sets.

For example, a notification of information indicating resource blocks of a physical DL shared channel (PDSCH) and a physical uplink (UL) shared channel (PUSCH) to be used by each terminal in DL and UL is provided by a physical DL control channel (PDCCH).

A CC into which the PDCCH is inserted is being considered to be transmitted in only a monitoring CC so as to reduce a load of blind decoding for detecting the PDCCH. In this case, in general, because the number of monitoring CC sets is less than the number of DL-CC sets, cross scheduling is used. As the cross scheduling, the PDSCH of a separate CC is scheduled by control information of the PDCCH of a certain CC. That is, in the cross scheduling, the PDCCH is used to schedule the PDSCH of a CC different from a CC including the PDCCH. Thus, when the PDCCH is transmitted, it is necessary to designate a CC, the PDSCH or PUSCH of which is indicated by the control information of the PDCCH.

Thus, the introduction of a frequency band identifier (CC-ID) serving as an ID for specifying a CC and the allocation of a carrier indicator field (CIF) for transmitting the CC-ID on the PDCCH have been proposed. Information arranged in the CIF can specify a CC by 1 to 3 bits.

In addition, as is known, no CC-ID is added to control information of the PDCCH (on which scheduling information is transmitted) indicating the PUSCH forming only one pair with the PDSCH within the same CC as in the PDCCH.

On the other hand, a method of reducing the number of bits of the CIF is also being studied. As disclosed in Non-Patent Document 2, the CC-ID is allocated to only a CC other than an anchor carrier (AC), that is, the CC-ID is not allocated to the AC.

### PRIOR ART DOCUMENTS

### Non-Patent Documents

Non-Patent Document 1: 3GPP TS36.101 V9.2.0
Non-Patent Document 2: 3GPP Contribution R1-0094677

### DISCLOSURE OF INVENTION

### Problem to be Solved by the Invention

However, in the technology disclosed in Non-Patent Document 2, when the CC-ID is not added to the PDCCH, there is a disadvantage in that it is not possible to specify whether the PDSCH or PUSCH indicated by the control information of the PDCCH is the same CC as in the PDCCH or the AC. That is, in the technology disclosed in Non-Patent Document 2, there is a disadvantage in that it is not possible to flexibly and reliably specify a frequency band (CC).

The present invention has been made in view of the above-described circumstances, and provides a communication system, a communication apparatus, a communication control method, and a communication control program capable of flexibly and reliably specifying a frequency band.

### Means to Solve the Problem

(1) The present invention was made to solve the above-described problem, a first aspect of the present invention is a communication system including a first communication apparatus and a second communication apparatus that communicates with the first communication apparatus using a plurality of frequency bands, wherein: the first communication apparatus designates a frequency band indicated by control information to be arranged in the frequency band using a frequency band identifier based on correspondence information in which the frequency band identifier and the frequency band are associated among different correspondence information for every frequency band in which a signal of the control information is arranged, and the second communication apparatus selects a frequency band indicated by control information arranged in the frequency band using a frequency band identifier based on correspondence information in which the frequency band identifier and the frequency band are associated among different correspondence information for every frequency band in which a signal of the control information is arranged.

(2) In the first aspect of the present invention, the first communication apparatus may designate a frequency band in which information to be controlled by the control information is arranged, and the second communication apparatus may select a frequency band in which information to be controlled by the control information is arranged.

(3) In the first aspect of the present invention, the first communication apparatus may not transmit the frequency band identifier indicating the frequency band in which the information to be controlled by the control information is arranged, and the second communication apparatus may select a frequency band in which the control information is arranged as the frequency band in which the information to be controlled by the control information is arranged in case that there is no frequency band identifier.

(4) In the first aspect of the present invention, the first communication apparatus may determine and transmit the correspondence information, and the second communication apparatus may select the frequency band indicated by the control information arranged in the frequency band using the frequency band identifier based on the correspondence information received from the first communication apparatus.

(5) In the first aspect of the present invention, the second communication apparatus may transmit a reception completion notification indicating that the correspondence information has been received from the first communication apparatus, the first communication apparatus may transmit a reception acknowledgement notification indicating that the reception completion notification has been received from the second communication apparatus, and designate the frequency band indicated by the control information to be arranged in the frequency band using the correspondence information after a predetermined period has elapsed from the transmission of the reception acknowledgement notification, and the second communication apparatus may receive the reception acknowledgement notification from the first communication apparatus, and select the frequency band indicated by the control information to be arranged in the frequency band using the correspondence information after a predetermined period has elapsed from the reception.

(6) In the first aspect of the present invention, the first communication apparatus may determine the correspondence information according to a predetermined rule based on frequency band information indicating the frequency band and transmit the frequency band information, and the second communication apparatus may determine the correspondence information according to the rule based on the frequency band information received from the first communication apparatus.

(7) In the first aspect of the present invention, the second communication apparatus may transmit a reception completion notification indicating that the frequency band information has been received from the first communication apparatus, the first communication apparatus may transmit a reception acknowledgement notification indicating that the reception completion notification has been received from the second communication apparatus, and designate the frequency band indicated by the control information to be arranged in the frequency band using a determined frequency band identifier after a predetermined period has elapsed from the transmission, and the second communication apparatus may receive the reception acknowledgement notification from the first communication apparatus, and select the frequency band indicated by the control information to be arranged in the frequency band using the determined frequency band identifier after a predetermined period has elapsed from the reception.

(8) In the first aspect of the present invention, the first communication apparatus may transmit the control information including the frequency band identifier, and the second communication apparatus may extract the frequency band identifier from the control information received from the first communication apparatus, and select the frequency band indicated by the control information arranged in the frequency band using the extracted frequency band identifier.

(9) A second aspect of the present invention is a communication apparatus, which communicates with another communication apparatus using a plurality of frequency bands, wherein a frequency band indicated by control information to be arranged in the frequency band using a frequency band identifier is designated based on correspondence information in which the frequency band identifier and the frequency band are associated among different correspondence information for every frequency band in which a signal of the control information is arranged.

(10) A third aspect of the present invention is a communication apparatus, which communicates with another communication apparatus using a plurality of frequency bands, wherein a frequency band indicated by control information arranged in the frequency band using a frequency band identifier is selected based on correspondence information in which the frequency band identifier and the frequency band are associated among different correspondence information for every frequency band in which a signal of the control information is arranged.

(11) A fourth aspect of the present invention is a communication control method for use in a first communication apparatus, which communicates with a second communication apparatus using a plurality of frequency bands, the communication control method including: designating, by the second communication apparatus, a frequency band indicated by control information to be arranged in the frequency band using a frequency band identifier based on correspondence information in which the frequency band identifier and the frequency band are associated among different correspondence information for every frequency band in which a signal of the control information is arranged.

(12) A fifth aspect of the present invention is a communication control method for use in a second communication apparatus, which communicates with a first communication apparatus using a plurality of frequency bands, the communication control method including: selecting, by the first communication apparatus, a frequency band indicated by control information arranged in the frequency band using a frequency band identifier based on correspondence information in which the frequency band identifier and the frequency band are associated among different correspondence information for every frequency band in which a signal of the control information is arranged.

(13) A sixth aspect of the present invention is a communication control program for causing a computer of a first communication apparatus, which communicates with a second communication apparatus using a plurality of frequency bands, the communication control program executing: designating a frequency band indicated by control information to be arranged in the frequency band using a frequency band identifier based on correspondence information in which the frequency band identifier and the frequency band are associated among different correspondence information for every frequency band in which a signal of the control information is arranged.

(14) A seventh aspect of the present invention is a communication control program for causing a computer of a second communication apparatus, which communicates with a first communication apparatus using a plurality of frequency bands, the communication control program executing: selecting a frequency band indicated by control information arranged in the frequency band using a frequency band identifier based on correspondence information in which the frequency band identifier and the frequency band are associated among different correspondence information for every frequency band in which a signal of the control information is arranged.

### Effect of the Invention

According to the present invention, it is possible to flexibly and reliably specify a frequency band.

### BRIEF DESCRIPTION OF THE DRAWINGS

FIG. 1 is a schematic diagram illustrating an example of DL communication in accordance with an embodiment of the present invention.

FIG. 2 is a schematic block diagram illustrating a configuration of a terminal apparatus in accordance with this embodiment.

FIG. 3 is a schematic diagram illustrating an example of a CC-ID list in accordance with this embodiment.

FIG. 4 is a schematic diagram illustrating another example of a CC-ID list in accordance with this embodiment.

FIG. 5 is a schematic block diagram illustrating a configuration of a resource information acquiring unit in accordance with this embodiment.

FIG. 6 is a schematic block diagram illustrating a configuration of a base station apparatus in accordance with this embodiment.

FIG. 7 is a schematic block diagram illustrating a configuration of an information setting unit of the base station apparatus in accordance with this embodiment.

FIG. 8 is a schematic block diagram illustrating a configuration of an information setting unit of a terminal apparatus in accordance with this embodiment.

FIG. 9 is a sequence diagram illustrating an example of an operation of a communication system in accordance with this embodiment.

FIG. 10 is a sequence diagram illustrating another example of an operation of a communication system in accordance with this embodiment.

FIG. 11 is a schematic block diagram illustrating a configuration of an information setting unit of a base station apparatus in accordance with a modified example of this embodiment.

FIG. 12 is a schematic block diagram illustrating a configuration of an information setting unit of a terminal apparatus in accordance with this modified example.

### BEST MODE FOR CARRYING OUT THE INVENTION

Hereinafter, an embodiment of the present invention will be described in detail with reference to the drawings.

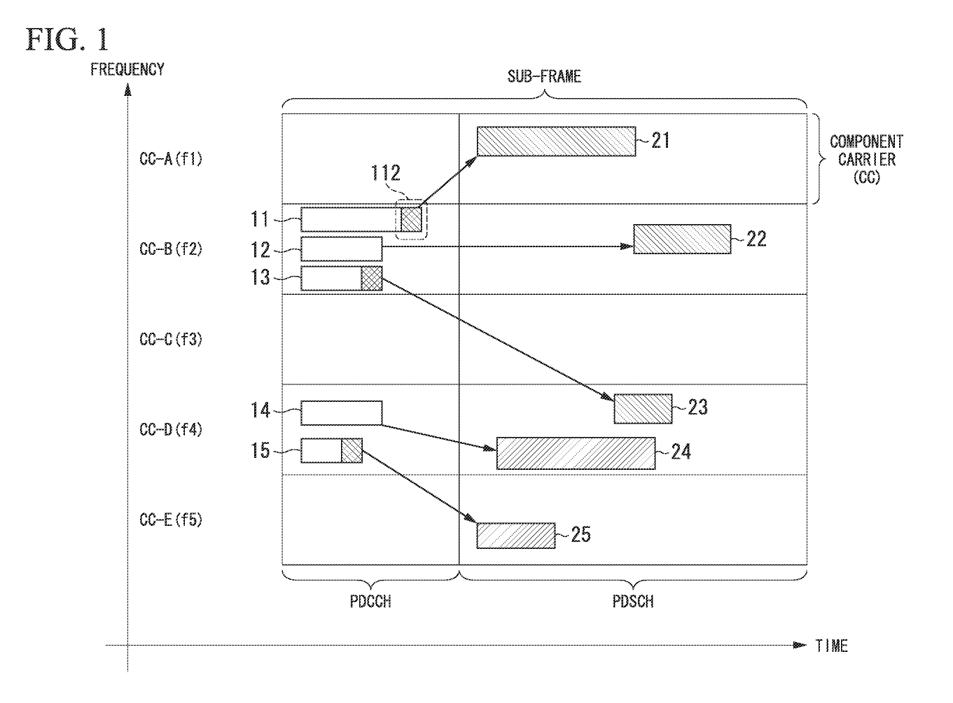

FIG. 1 is a schematic diagram illustrating an example of DL communication in accordance with the embodiment of the present invention. In the following embodiment, the case in which a base station apparatus and a terminal apparatus perform the DL communication under the following conditions (1) to (6) will be described. However, the present invention is not limited to these conditions.

(1) DL-CC count: 5 CCs

Here, the DL-CC count is the number of CCs in which the terminal receives the DL communication. As illustrated in FIG. 1, the 5 CCs are used in the DL communication. In addition, a combination of CCs in the DL communication is referred to as a DL-CC set. In addition, DL-CCs are referred to as follows.

(2) Frequency band information of the DL-CCs: CC-A (f1), CC-B (f2), CC-C (f3), CC-D (f4), and CC-E (f5)

Here, the frequency band information is information for identifying a CC. Reference signs within parentheses indicate a frequency band corresponding to each DL-CC. In FIG. 1, frequency bands f1, f2, f3, f4, and f5 are illustrated in descending order of frequency. Hereinafter, the frequency band is referred to as frequency band information. A relationship between identification information such as CC-A and a frequency band may be pre-associated and the identification information such as CC-A may be used.

(3) Monitoring CCs: CC-B and CC-D

The monitoring CCs are CCs in which control information (including mapping information (scheduling information)) is arranged for user data of the PDSCH. In these CCs, pieces of the control information for the user data are arranged in different DL control information (DCI) formats. In FIG. 1, the arrangement of control information 11, 12, and 13 with reference signs 11, 12, and 13 is indicated in CC-B. In addition, in FIG. 1, the arrangement of control information 14 and 15 with reference signs 14 and 15 is indicated in CC-B.

Here, user data to be controlled by the control information is that of CCs identical to or different from monitoring CCs. The mapping information is information indicating a resource block within a CC in which user data addressed to a terminal apparatus 1a is arranged. That is, the mapping information is data arrangement information within the CC.

(4) The user data is arranged in CC-A, CC-B, CC-D, and CC-E.

Here, one piece of user data is arranged in each of CC-A, CC-B, and CC-E. In addition, two pieces of user data are arranged in CC-D.

As illustrated in FIG. 1, user data 21, 22, and 25 with reference signs 21, 22, and 25 is arranged in CC-A, CC-B, and CC-E, respectively. In addition, as illustrated, user data 23 and 24 with reference signs 23 and 24 is arranged in CC-D.

(5) Control information for user data of a PDSCH of (one of) CC-A, CC-B, and CC-D is arranged in CC-B.

As illustrated in FIG. 1, control information 11, 12, and 13 is control information for the user data 21, 22, and 23, respectively.

(6) Control information for user data of a PDSCH of (one of) CC-D and CC-E is arranged in CC-B. As illustrated in FIG. 1, control information 14 and 15 is control information for the user data 24 and 25, respectively.

In addition, in FIG. 1, a CIF is allocated to the control information 11 13, and 15. In the CIF, a cross-hatched frequency band ID (CC-ID; for example, information with reference sign 112 in the control information 11) is arranged. On the other hand, the CIF is not allocated to the control information 12 and 14. That is, because no CIF is allocated to control information for user data of the PDSCH of the same CC as in the PDCCH, no CC-ID is arranged either. The terminal apparatus stores frequency information (a frequency band) of each CC in advance.

<Configuration of Terminal Apparatus 1a>

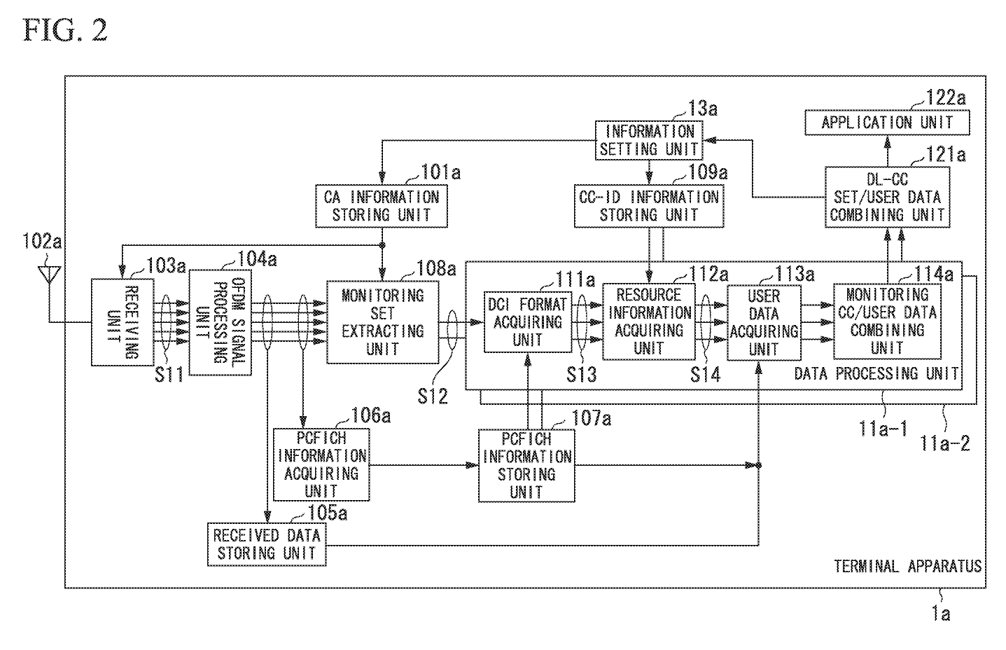

FIG. 2 is a schematic block diagram illustrating a configuration of the terminal apparatus 1a in accordance with this embodiment. In FIG. 2, the terminal apparatus 1a includes a CA information storing unit 101a, an antenna 102a, a receiving unit 103a, an orthogonal frequency division multiplexing (OFDM) signal processing unit 104a, a received data storing unit 105a, a physical control format indicator channel (PCFICH) information acquiring unit 106a, a PCFICH information storing unit 107a, a monitoring set extracting unit 108a, a CC-ID information storing unit 109a, data processing units 11a-1 and 11a-2, a DL-CC set/user data combining unit 121a, an application unit 122a, and an information setting unit 13a.

Here, the data processing unit is provided for every monitoring CC. The data processing units 11a-1 and 11a-2 correspond to CC-B and CC-D, respectively. Each of the data processing units 11a-1 and 11a-2 includes a DCI format acquiring unit 111a, a resource information acquiring unit 112a, a user data acquiring unit 113a, and a monitoring CC/user data combining unit 114a. Because the functions provided in the data processing units 11a-1 and 11a-2 are identical, the data processing unit 11a-1 will be representatively described hereinafter.

In addition, the terminal apparatus 1a additionally has general known functions (for example, a screen, a speaker, a microphone, and an input button) of the terminal apparatus.

The CA information storing unit 101a stores CA information input from the information setting unit 13a, which is CA information of a notification provided from the base station apparatus 1b in advance. Here, the CA information includes frequency band information of an AC, frequency band information (referred to as DL-CC set information) of each CC included in the DL-CC set, and frequency band information of a monitoring CC (referred to as monitoring set information). The AC is a carrier for monitoring the presence/absence of communication in a state in which this carrier is only receivable while the terminal apparatus is on standby. In this embodiment, the case in which CC-B, which is one of monitoring CCs, is selected as the AC will be described.

The CA information storing unit 101a outputs DL-CC set information to the receiving unit 103a. In addition, the CA information storing unit 101a outputs monitoring set information to the monitoring set extracting unit 108a.

The receiving unit 103a receives a signal of DL communication in each frequency band indicated by the DL-CC set information input from the CA information storing unit 101a. The receiving unit 103a down-converts a signal for every received CC, and outputs the down-converted signal to the OFDM signal processing unit 104a. The number of signals for every CC is a DL-CC count (5 in FIG. 1). In addition, the receiving unit 103a outputs the signals for every CC in association with frequency band information of DL-CC set information, which is frequency band information of the received CC.

The OFDM signal processing unit 104a acquires received data for every CC from the signals input from the receiving unit 103a. Specifically, the OFDM signal processing unit 104a converts each signal input from the receiving unit 103a according to analog to digital conversion, and removes a guard interval. The OFDM signal processing unit 104a acquires received data by performing a fast Fourier transform and demapping of a signal after the removal and demodulating the demapped signal.

The OFDM signal processing unit 104a outputs the acquired received data to the received data storing unit 105a, the PCFICH information acquiring unit 106a, and the monitoring set extracting unit 108a.

The received data storing unit 105a stores the received data for every CC input from the OFDM signal processing unit 104a. The received data storing unit 105a outputs the stored received data to the user data acquiring unit 113a.

The PCFICH information acquiring unit 106a extracts PCFICH information from the received data for every CC input from the OFDM signal processing unit 104a. Here, the PCFICH information includes information indicating the number of OFDM symbols allocated to the PDCCH within a transmitted CC of the PCFICH. The PCFICH information acquiring unit 106a outputs the extracted PCFICH information to the PCFICH information storing unit 107a.

The PCFICH information storing unit 107a stores the PCFICH information input from the PCFICH information acquiring unit 106a. The PCFICH information storing unit 107a outputs the stored PCFICH information to the DCI format acquiring unit 111a and the user data acquiring unit 113a.

The monitoring set extracting unit 108a extracts data of a signal arranged in the monitoring CC based on frequency band information of the monitoring set information input from the CA information storing unit 101a. The monitoring set extracting unit 108a outputs data for every extracted monitoring CC to the DCI format acquiring unit 111a of the corresponding data processing unit 11a-1. Specifically, the monitoring set extracting unit 108a outputs data of signals arranged in CC-B and CC-D to the DCI format acquiring units 111a of the data processing units 11a-1 and 11a-2. The monitoring set extracting unit 108a may extract only data of a signal arranged in the PDCCH among data for every monitoring CC, and output the extracted data to the corresponding DCI format acquiring unit 111a.

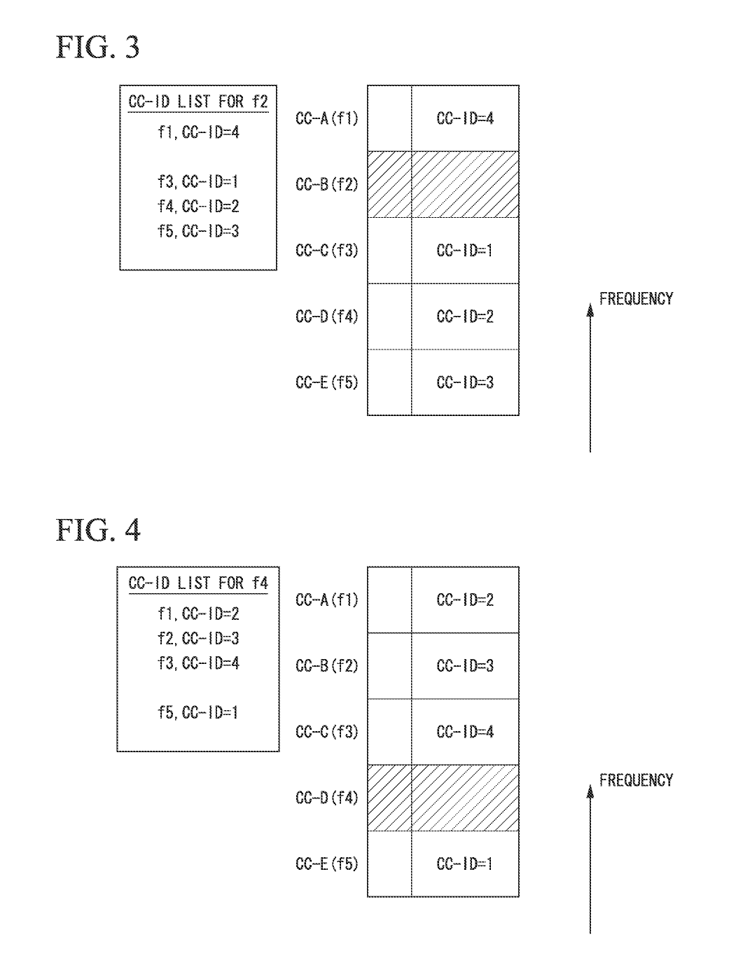

The CC-ID information storing unit 109a stores the CC-ID information input from the information setting unit 13a. Here, CIF size information indicating a length of a CIF for every DCI format and a CC-ID list (see FIG. 3) for every piece of frequency band information of the monitoring CC is stored as the CC-ID information. Here, the CIF size information is information indicating the number of CIF bits. In addition, the CC-ID list is a list of information in which frequency band information and CC-IDs are associated.

The DCI format acquiring unit 111a of the data processing units 11a-1 extracts control information arranged in each DCI format based on the PCFICH information input from the PCFICH information storing unit 107a. That is, a notification of the number of OFDM symbols allocated to the PDCCH within one sub-frame is provided from the PCFICH information. A data size of the PDCCH for performing blind decoding is specified from a frequency bandwidth to be used as the number of symbols of the PDCCH. Next, the DCI format acquiring unit 111a extracts control information of the DCI format using the blind decoding. Thereby, the DCI format acquiring unit 111a can extract control information of different DCI formats and extract control information of a plurality of identical or different DCI formats. Specifically, in the case of DL communication illustrated in FIG. 1, the DCI format acquiring unit 111a extracts control information 11, 12, and 13 using three DCI formats.

Here, the control information includes control information (referred to as self CC control information) for user data of the same CC (CC-B) and control information (referred to as other CC control information) for user data of different CCs (other than CC-B). In addition, as illustrated in FIG. 1, in the other CC control information, a CIF is allocated and a CC-ID is arranged. On the other hand, in the self CC control information, no CIF is allocated and no CC-ID is arranged.

The DCI format acquiring unit 111a outputs the extracted control information to the resource information acquiring unit 112a for every piece of control information of the DCI format (the control information 11, 12, and 13 in the example of FIG. 1).

The resource information acquiring unit 112a extracts mapping information between a CC-ID of a CC in which user data (to be controlled by control information) is arranged for control information from the control information input from the DCI format acquiring unit 111a and the CC of the CC-ID based on the CIF length indicated by the CC-ID information input from the CC-ID information storing unit 109a. A CC-ID list of CC-ID information input from the CC-ID information storing unit 109a is different for every data processing unit (monitoring CC) (and may be identical in some data processing units). Consequently, in the resource information acquiring units 112a of the data processing units 11a-1 and 11a-2, the extracted CC-ID becomes different even when a CC in which user data for control information is arranged is a CC of the same frequency band information.

The resource information acquiring unit 112a converts the extracted CC-ID into frequency band information associated with CC-ID information. The resource information acquiring unit 112a outputs the frequency band information after the conversion and the mapping information to the user data acquiring unit 113a for every piece of the control information. Details of a process to be performed by the resource information acquiring unit 112a will be described later.

Received data for every CC from the received data storing unit 105a is input to the user data acquiring unit 113a. The user data acquiring unit 113a selects received data of a CC indicated by the frequency band information input from the resource information acquiring unit 112a for every piece of control information, and extracts the user data using the mapping information (data arrangement information within the CC) from the selected received data. That is, the user data acquiring unit 113a selects a CC indicated by control information arranged in a monitoring CC using a different CC-ID for every monitoring CC in which a signal of control information is arranged. The user data acquiring unit 113a outputs the extracted user data to the monitoring CC/user data combining unit 114a for every piece of control information.

The monitoring CC/user data combining unit 114a combines user data for every piece of control information input from the user data acquiring unit 113a. That is, for every monitoring CC, user data indicated by the control information arranged in the CC is combined. The monitoring CC/user data combining unit 114a outputs the combined user data to the DL-CC set/user data combining unit 121a.

The DL-CC set/user data combining unit 121a combines user data input from the monitoring CC/user data combining units 114a of the data processing units 11a-1 and 11a-2. The DL-CC set/user data combining unit 121a outputs the combined user data to the application unit 122a and the information setting unit 13a.

The application unit 122a executes an application based on the user data input from the DL-CC set/user data combining unit 121a.

The information setting unit 13a acquires the CA information and the CC-ID information from the user data input from the DL-CC set/user data combining unit 121a. The information setting unit 13a outputs the acquired CA information to the CA information storing unit 101a. The information setting unit 13a outputs the acquired CC-ID information to the CC-ID information storing unit 109a.

Details of a process to be performed by the information setting unit 13a will be described later.

<CC-ID List>

FIGS. 3 and 4 are schematic diagrams illustrating examples of the CC-ID list in accordance with this embodiment. Here, FIGS. 3 and 4 illustrate CC-ID lists in which frequency band information of monitoring CCs are “f2” (CC-B) and “f4” (CC-D). In addition, the CC-ID lists of FIGS. 3 and 4 are each input to the resource information acquiring units 112a of the data processing units 11a-1 and 11a-2.

In FIGS. 3 and 4, the frequency band information is illustrated in descending order of frequency as CCs of f1, f2, f3, f4, and f5.

In FIG. 3, for example, frequency band information “f1” is associated with CC-ID “4.” That is, for control information arranged in the monitoring CC of “f2,” the frequency band of frequency band information “f1” is designated as CC-ID “4.”

In addition, as illustrated in FIG. 3, frequency band information “f2” is not in the CC-ID list. That is, a CC of frequency band information “f2,” which is the monitoring CC, is designated without a CIF and hence is not associated with any CC-ID either, as illustrated.

FIG. 3 is an example in which CC-IDs are allocated according to cyclic numbers (4→1→2→3) while the order of CC-ID number (natural number) is shifted by 2 pieces in order of CC frequency band information in descending order of frequency (f1→f2→f3→f4→f5).

In FIG. 4, for example, frequency band information “f1” is associated with CC-ID “2.” That is, for control information arranged in a monitoring CC of “f4,” the frequency band of frequency band information “f1” is designated as CC-ID “2.” As described above, in FIGS. 3 and 4, an allocated CC-ID is different even in the CC of the same frequency band information.

FIG. 4 is an example in which CC-IDs are allocated according to cyclic numbers (2→3→4→1) while the order of CC-ID number (natural number) is shifted by 4 pieces in order of CC frequency band information in descending order of frequency (f1→f2→f3→f4→f5).

<Resource Information Acquiring Unit 112a>

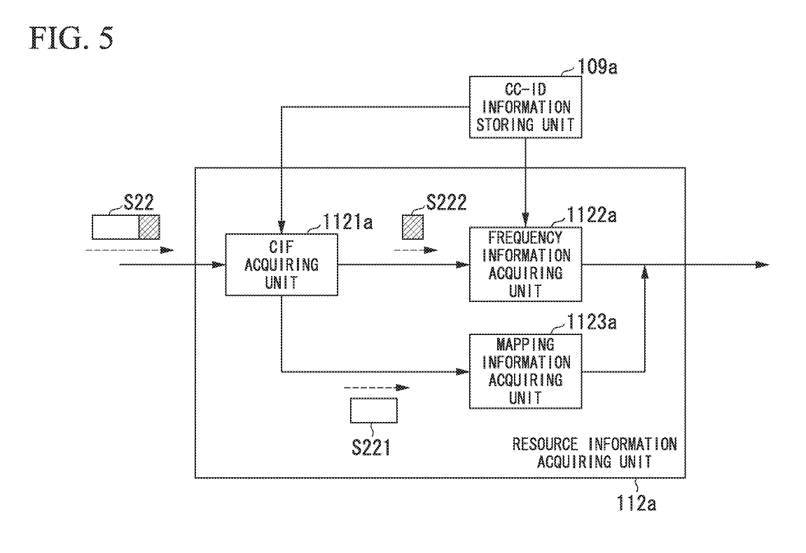

FIG. 5 is a schematic block diagram illustrating a configuration of the resource information acquiring unit 112a in accordance with this embodiment. In FIG. 5, the resource information acquiring unit 112a includes a CIF acquiring unit 1121a, a frequency information acquiring unit 1122a, and a mapping information acquiring unit 1123a.

The CIF acquiring unit 1121a receives an input of control information with reference sign S22. Here, a DCI format of self CC control information is different from a DCI format of other CC control information. The CIF acquiring unit 1121a determines whether the input control information is the self CC control information or the other CC control information based on a DCI format stored in advance.

When the input control information is determined to be the self CC control information, the CIF acquiring unit 1121a directly outputs the input control information to the mapping information acquiring unit 1123a. In addition, in this case, the CIF acquiring unit 1121a outputs information indicating that “there is no CIF” to the frequency information acquiring unit 1122a.

On the other hand, when the input control information is determined to be the other CC control information, the CIF acquiring unit 1121a divides the information into information on a CIF and information excluding the CIF based on the CIF size information input from the CC-ID information storing unit 109a. The CIF acquiring unit 1121a outputs the information excluding the CIF after the division to the mapping information acquiring unit 1123a. In addition, the CIF acquiring unit 1121a outputs the CIF information after the division to the frequency information acquiring unit 1122a.

In the configuration of the DCI format including the CIF, an unused part (the arrangement information of which is not determined) in the DCI format in accordance with the related art (for example, technology disclosed in 3GPP Rel. 8) may be allocated as the CIF. For example, n bits from behind in the DCI format are allocated as the CIF.

In addition, CIF bits may be added to an outer portion of the DCI format in accordance with the related art. For example, n CIF bits may be added immediately after the DCI format.

The frequency information acquiring unit 1122a converts the CIF information input from the CIF acquiring unit 1121a into a CC-ID according to a conversion rule common in the terminal apparatus 1a and the base station apparatus 1b. Specifically, when n=2 bits, for example, the CC-ID is expressed by a binary number. That is, if the CIF information (bit stream) is “00,” “01,” “10,” and “11,” the CC-IDs are set to “1,” “2,” “3,” and “4.” The conversion rule is not limited thereto. An N-ary (other than N=2) system may be used, and a predetermined function may be used. In addition, conversion may be performed using correspondence information between the CIF information and the CC-ID.

The frequency information acquiring unit 1122a converts a CC-ID after the conversion into frequency band information (frequency bands: f1, f2, . . . ) based on the CC-ID list input from the CC-ID information storing unit 109a. For example, if the converted CC-ID is “4,” the CC-ID is converted into frequency band information “f1” (CC-A) based on the CC-ID list of FIG. 3.

In addition, when information indicating that “there is no CIF” is input from the CIF acquiring unit 1121a, the frequency information acquiring unit 1122a reads frequency band information (f2 in this embodiment) indicating a pre-stored self CC (the same CC as the CC in which the control information is arranged). The frequency information acquiring unit 1122a outputs the frequency band information after the conversion or the read frequency band information as frequency band information of a CC in which user data for the control information is arranged.

The mapping information acquiring unit 1123a extracts mapping information from the information excluding the CIF input from the CIF acquiring unit 1121a. A CC in which user data for the mapping information is arranged is indicated by the frequency band information output by the frequency information acquiring unit 1122a.

The resource information acquiring unit 112a performs the above-described process, the number of times of which is the number of pieces of the extracted control information (the number of DCI formats) and outputs the frequency band information and the mapping information for every piece of control information.

<Configuration of Base Station Apparatus 1b>

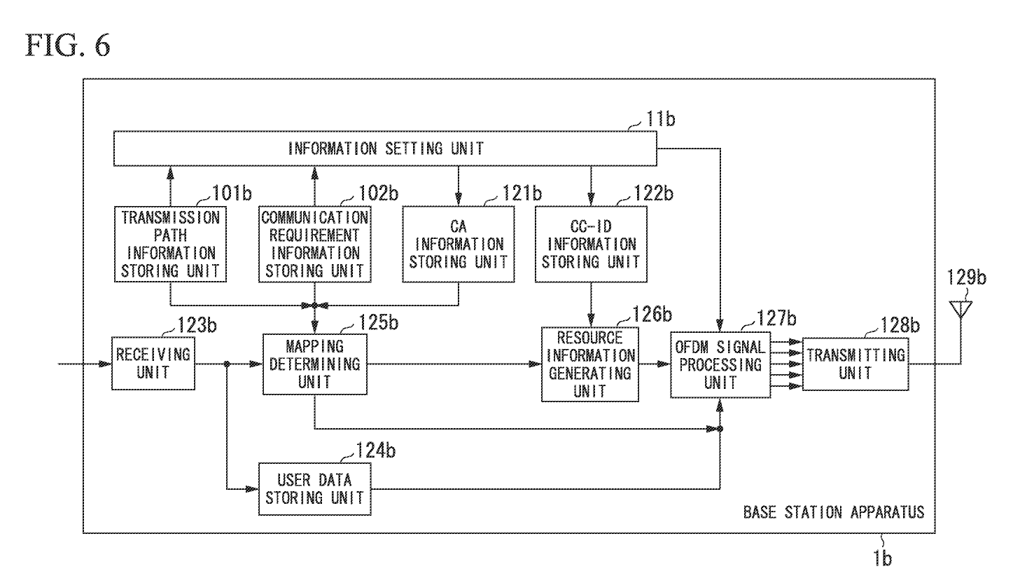

FIG. 6 is a schematic block diagram illustrating a configuration of the base station apparatus 1b in accordance with this embodiment. In FIG. 6, the base station apparatus 1b includes a propagation channel information storing unit 101b, a communication requirement information storing unit 102b, an information setting unit 11b, a CA information storing unit 121b, a CC-ID information storing unit 122b, a receiving unit 123b, a user data storing unit 124b, a mapping determining unit 125b, a resource information generating unit 126b, an OFDM signal processing unit 127b, a transmitting unit 128b, and an antenna 129b.

The propagation channel information storing unit 101b stores a channel quality indicator (CQI) indicating the quality of a propagation channel between the terminal apparatus 1a and the base station apparatus 1b. A notification of the CQI is provided from the terminal apparatus 1a. The propagation channel information storing unit 101b outputs the stored CQI to the mapping determining unit 125b and the information setting unit 11b.

The communication requirement information storing unit 102b stores quality of service (QoS) indicating a communication requirement between the terminal apparatus 1a and the base station apparatus 1b. The communication requirement information storing unit 102b outputs the stored QoS to the mapping determining unit 125b and the information setting unit 11b.

The information setting unit 11b generates CA information and CC-ID information for every terminal apparatus 1a based on the CQI input from the propagation channel information storing unit 101b and the QoS input from the communication requirement storing unit 102b. The information setting unit 11b outputs the generated CA information to the CA information storing unit 121b, and outputs the generated CC-ID information to the CC-ID information storing unit 122b. In addition, the information setting unit 11b outputs the CA information and the CC-ID information generated for every terminal apparatus 1a as data addressed to the terminal apparatus 1a to the OFDM signal processing unit 127b.

Details of a process to be performed by the information setting unit 11b will be described later.

The CA information storing unit 121b stores the CA information input from the information setting unit 11b for every terminal apparatus 1a. The CA information storing unit 121b outputs the stored CA information to the mapping determining unit 125b.

The CC-ID information storing unit 122b stores the CC-ID information input from the information setting unit 11b for every terminal apparatus 1a. The CC-ID information storing unit 122b outputs the stored CC-ID information to the mapping determining unit 125b and the resource information generating unit 126b.

The receiving unit 123b is connected to a core network (CN), and receives user data addressed from another apparatus to each terminal apparatus 1a. The receiving unit 123b outputs the received user data to the mapping determining unit 125b and the user data storing unit 124b.

The user data storing unit 124b stores the user data input from the receiving unit 123b. The user data storing unit 124b outputs the stored user data to the OFDM signal processing unit 127b.

The mapping determining unit 125b determines mapping within a CC in each terminal apparatus 1a based on the CQI input from the propagation channel information storing unit 101b, the QoS input from the communication requirement information storing unit 102b, and the user data input from the receiving unit 123b. Specifically, the mapping determining unit 125b determines mapping of the user data to the PDSCH according to availability of the PDSCH.

The mapping determining unit 125b outputs the mapping information indicating the determined mapping to the resource information generating unit 126b and the OFDM signal processing unit 127b.

The resource information generating unit 126b extracts mapping information for every CC of the user data from the mapping information input from the mapping determining unit 125b. The resource information generating unit 126b allocates a CIF to control information when a CC (monitoring CC) in which the extracted mapping information is arranged is different from a CC in which the user data is arranged.

The resource information generating unit 126b converts frequency band information of the CC in which the user data is arranged into a CC-ID based on the CC-ID information input from the CC-ID information storing unit 122b. The resource information generating unit 126b generates control information including the mapping information and the CC-ID (when the CIF has been allocated) according to the DCI format. The resource information generating unit 126b outputs the generated control information to the OFDM signal processing unit 127b.

The OFDM signal processing unit 127b converts the control information input from the resource information generating unit 126b and the user data input from the user data storing unit 124b into a signal, and outputs the signal to the transmitting unit 128b. Specifically, the OFDM signal processing unit 127b encodes and modulates the control data and the user data. The OFDM signal processing unit 127b maps the signal after the modulation based on the mapping information input from the mapping determining unit 125b. The OFDM signal processing unit 127b transforms the mapped signal according to an inverse fast Fourier transform, and inserts a guard interval into the transformed signal. The OFDM signal processing unit 127b converts the signal after the insertion according to digital to analog conversion, and outputs the converted signal to the transmitting unit 128b.

The transmitting unit 128b up-converts the signal input from the OFDM signal processing unit 127b, and transmits the up-converted signal via the antenna 129b.

<Information Setting Process>

Hereinafter, details of a process to be performed by the information setting units 11b and 13a will be described.

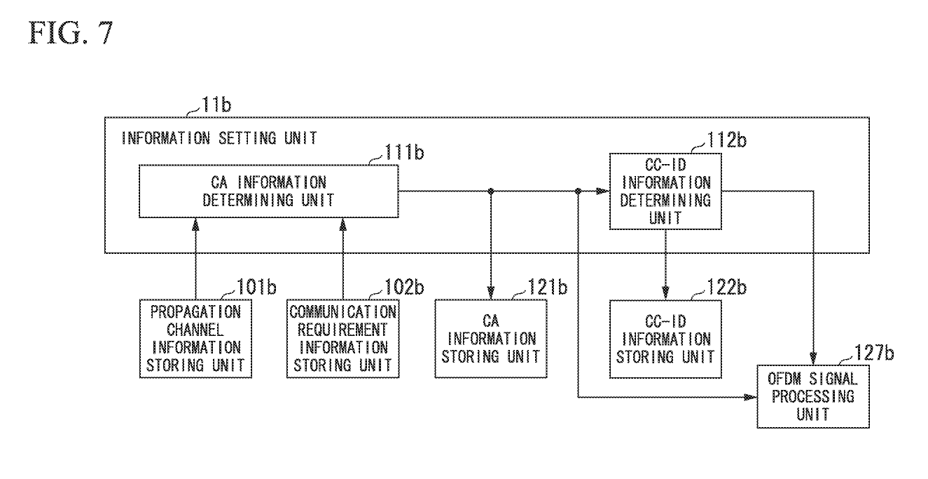

FIG. 7 is a schematic block diagram illustrating a configuration of the information setting unit 11b of the base station apparatus 1b in accordance with this embodiment. In FIG. 7, the information setting unit 11b includes a CA information determining unit 111b and a CC-ID information setting unit 112b.

The CA information determining unit 111b determines an AC, a DL-CC set, and a monitoring CC for every terminal apparatus 1a based on the CQI input from the propagation channel information storing unit 101b and the QoS input from the communication requirement information storing unit 102b. The CA information determining unit 111b generates CA information indicating the determined AC, DL-CC set, and monitoring CC. The CA information determining unit 111b outputs the CA information generated for every terminal apparatus 1a to the CA information storing unit 121b, the CC-ID information determining unit 112b, and the OFDM signal processing unit 127b. The CA information output to the OFDM signal processing unit 127b is transmitted to the terminal apparatus 1a of the CA information.

The CC-ID information determining unit 112b generates CIF size information for every terminal apparatus 1a and a CC-ID list for every monitoring CC of the terminal apparatus 1a based on the CA information input from the CA information determining unit 111b.

Specifically, the CC-ID information determining unit 112b calculates a number by subtracting 1 from the number of CCs included in the DL-CC set, and determines the minimum number of bits, n, capable of indicating the number. For example, when the CC-ID is a binary number, the CC-ID information determining unit 112b determines a minimum number of n that satisfies that Number of CCs−1≦2ⁿ as a CIF size. In addition, for example, the CC-ID information determining unit 112b allocates a number M (M is a natural number) to the monitoring CC in ascending order. The CC-ID information determining unit 112b generates the CC-ID list while shifting order of CC-ID number by M pieces and allocating CC-IDs according to cyclic numbers in order of CC frequency band information of descending order of frequency for every monitoring CC.

The present invention is not limited thereto. The CC-ID information determining unit 112b may determine the CIF size and allocate the CC-IDs according to another process.

The CC-ID information determining unit 112b outputs the CC-ID information including the determined CIF size and the generated CC-ID list to the CC-ID information storing unit 122b and the OFDM signal processing unit 127b. The CC-ID information output to the OFDM signal processing unit 127b is transmitted to the terminal apparatus 1a of the CC-ID information.

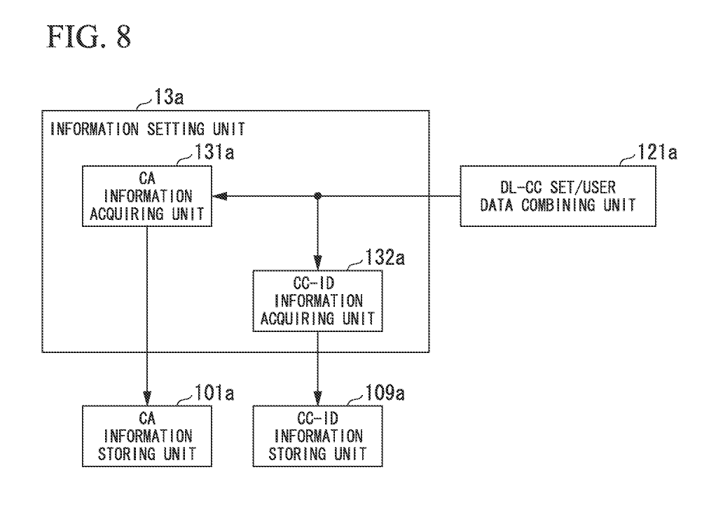

FIG. 8 is a schematic block diagram illustrating the information setting unit 13a of the terminal apparatus 1a in accordance with this embodiment. In FIG. 8, the information setting unit 13a includes a CA information acquiring unit 131a and a CC-ID information acquiring unit 132a.

The CA information acquiring unit 131a acquires CA information from the user data input from the DL-CC set/user data combining unit 121a, and outputs the acquired CA information to the CA information storing unit 101a.

The CC-ID information acquiring unit 132a acquires CC-ID information from the user data input from the DL-CC set/user data combining unit 121a, and outputs the acquired CC-ID information to the CC-ID information storing unit 109a.

<Operation of Communication System>

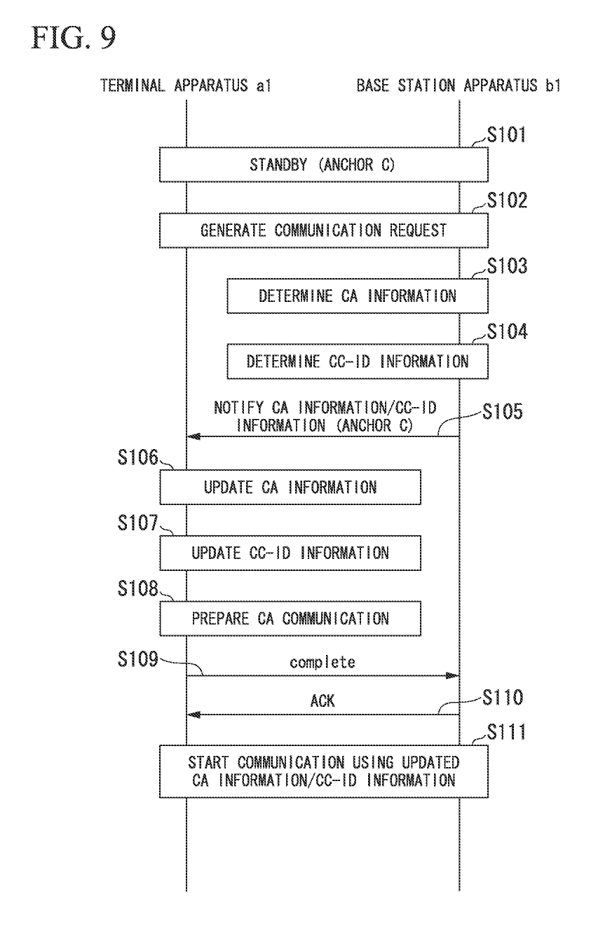

FIG. 9 is a sequence diagram illustrating an example of an operation of a communication system in accordance with this embodiment. FIG. 9 is an example in which a communication request has been generated in the terminal apparatus 1a in a standby state.

(Step S101) The terminal apparatus 1a is in the standby state of communication in CC-B, which is an AC. Thereafter, the process proceeds to step S102.

(Step S102) The communication request is generated in the terminal apparatus 1a or the base station apparatus 1b. Thereafter, the process proceeds to step S103.

(Step S103) The base station apparatus 1b determines and holds CA information. Thereafter, the process proceeds to step S104.

(Step S104) The base station apparatus 1b determines and holds CC-ID information. Thereafter, the process proceeds to step S105.

(Step S105) The base station apparatus 1b notifies the terminal apparatus 1a of the CA information and the CC-ID information determined in steps S103 and S104 using the AC. Thereafter, the process proceeds to step S106.

(Step S106) The terminal apparatus 1a holds the CA information of the notification in step S105 (updates a storage region of the CA information in the CA information of the notification). Thereafter, the process proceeds to step S107.

(Step S107) The terminal apparatus 1a holds the CC-ID information of the notification in step S105 (updates a storage region of the CC-ID information in the CC-ID information of the notification). Thereafter, the process proceeds to step S108.

(Step S108) The terminal apparatus 1a prepares communication using CA technology. Thereafter, the process proceeds to step S109.

(Step S109) The terminal apparatus 1a transmits a reception completion notification (complete) indicating that the CA information and the CC-ID information determined in steps S103 and S104 have been received to the base station apparatus 1b. Thereafter, the process proceeds to step S110.

When the reception completion notification has not been received in a predetermined period after step S105, the base station apparatus 1b returns to step S105. In addition, the reception completion notification may indicate that preparation has been completed in step S108.

(Step S110) The base station apparatus 1b transmits a reception acknowledgement notification (ACK) indicating that the reception completion notification of step S109 has been received to the terminal apparatus 1a. Thereafter, the process proceeds to step S111.

When the reception completion notification has not been received in the predetermined period after step S109, the terminal apparatus 1a returns to step S109.

(Step S111) The base station apparatus 1b starts DL communication using the CA information and the CC-ID information held in steps S103 and S104 after the predetermined period has elapsed (after m sub-frames) after the transmission of the reception acknowledgement notification in step S110. Specifically, a radio receiving unit (not illustrated) receives and demodulates a signal from the terminal apparatus 1a. The CC-ID information determining unit 112b of FIG. 7 extracts the reception completion notification from the received data processing unit (not illustrated) that processes received data of UL. The CC-ID information determining unit 112b outputs information indicating a sub-frame from which the reception completion notification has been detected to the resource information generating unit 126b via the CC-ID information storing unit 122b. The resource information generation unit 126b generates control information including the mapping information and the CC-IDs using the CC-ID information held in S104 from a sub-frame after m sub-frames from a sub-frame indicated by the input information.

In addition, the terminal apparatus 1a starts DL communication using the CA information and the CC-ID information held in steps S106 and S107 after the predetermined period has elapsed (after m sub-frames) after the receipt of the reception acknowledgement notification of step S110. Specifically, the CC-ID information acquiring unit 132a of FIG. 8 detects the reception acknowledgement notification from the DL-CC set/user data combining unit 121a. The CC-ID information acquiring unit 132a outputs information indicating a sub-frame from which the reception acknowledgement notification has been detected to the resource information acquiring unit 112a via the CC-ID information storing unit 109a. The resource information acquiring unit 112a extracts the CC-IDs and the mapping information using the CC-ID information held in S107 from a sub-frame after m sub-frames from a sub-frame indicated by the input information.

As described above, in step S111 or later, the CA information and the CC-ID information held in steps S103, S104, S106, and S107 are used in DL communication.

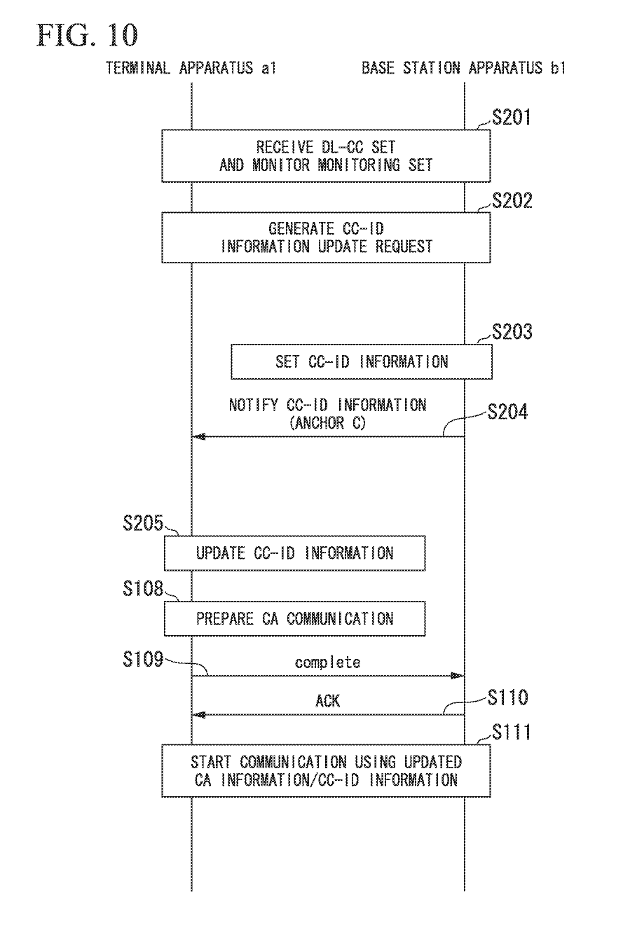

FIG. 10 is a sequence diagram illustrating another example of an operation of a communication system in accordance with this embodiment. FIG. 10 is an example in which the terminal apparatus 1a receives the CA information and monitors the monitoring CC. When the example of FIG. 10 is compared to the example of FIG. 9, the process of steps S108 to S111 is the same. In FIG. 10, description of the same process as in the example of FIG. 9 is omitted.

(Step S201) The terminal apparatus 1a receives the CA information, and monitors communication in the monitoring CC indicated by the CA information. Thereafter, the process proceeds to step S202.

(Step S202) The base station apparatus 1b or the terminal apparatus 1a determines to update the CC-ID information according to a change in transmission path information or communication requirement information. For example, when a CC having a CQI higher than that of the monitoring CC has been detected, it determines to update the CC-ID information so as to change the CC to the monitoring CC. The base station apparatus 1b or the terminal apparatus 1a generates a CC-ID information update request for requesting the update of the CC-ID information, and provides its notification to the base station apparatus 1b. Thereafter, the process proceeds to step S203.

(Step S203) The base station apparatus 1b determines and holds the CC-ID information. Thereafter, the process proceeds to step S204.

(Step S204) The base station apparatus 1b provides a notification of the CC-ID information determined in step S203 to the terminal apparatus 1a using the AC. Thereafter, the process proceeds to step S205.

(Step S205) The terminal apparatus 1a holds the CC-ID information of the notification provided in step S204 (updates a storage region of the CC-ID information in the CC-ID information of the notification). Thereafter, the process proceeds to step S108.

As described above, in this embodiment, the base station apparatus 1b designates a CC indicated by control information arranged in the monitoring CC using a different CC-ID for every monitoring CC in which a signal of the control information is arranged. The terminal apparatus 1a selects a CC indicated by the control information arranged in the monitoring CC using a different CC-ID for every monitoring CC in which the signal of the control information is arranged. Thereby, in this embodiment, the communication system can flexibly and reliably specify a CC indicated by control information of a control channel.

In addition, in this embodiment, the base station apparatus 1b designates a CC in which user data to be controlled by the control information is arranged, and selects a frequency band in which the user data to be controlled by the control information is arranged. Thereby, in this embodiment, the communication system can flexibly and reliably specify the CC in which the user data is arranged as a CC indicated by the control information of the control channel.

In addition, in this embodiment, the base station apparatus 1b does not transmit a CC-ID indicating the CC in which the user data to be controlled by the control information is arranged, and the terminal apparatus 1a selects a CC in which the control information is arranged as a frequency band in which the user data to be controlled by the control information is arranged when there is no CC-ID. Thereby, in this embodiment, the communication system can reduce information for the CC-ID.

In addition, according to this embodiment, the base station apparatus 1b determines and transmits a CC-ID list, which is correspondence information between CCs and CC-IDs, and the terminal apparatus 1a selects a CC indicated by control information arranged in the monitoring CC using the CC-ID list received from the base station apparatus 1b. Thereby, in this embodiment, the base station apparatus 1b can manage the CC-IDs and also flexibly cope with the CC-ID addition or format change.

In addition, according to this embodiment, the base station apparatus 1b designates a CC indicated by control information to be arranged in the monitoring CC using the CC-ID list after a predetermined period has elapsed from the transmission of a reception acknowledgement notification. In addition, the terminal apparatus 1a receives the reception acknowledgement notification and selects a CC indicated by control information arranged in the monitoring CC using the CC-ID list after the predetermined period has elapsed from the reception. Thereby, in this embodiment, the communication system can cause a timing of an application of the CC-ID list to be consistent between the terminal apparatus 1a and the base station apparatus 1b. In addition, the communication system can reliably apply the CC-ID list in the terminal apparatus 1a and the base station apparatus 1b because the CC-ID list is applied after the preparation of DL communication is completed.

### Modified Example

Hereinafter, the modified example of the above-described embodiment will be described.

In this modified example, the terminal apparatus 1a determines CC-ID information based on CA information of a notification from the base station apparatus 1b.

In this modified example, the communication system includes information setting units 21b and 23a instead of the information setting units 11b and 13a.

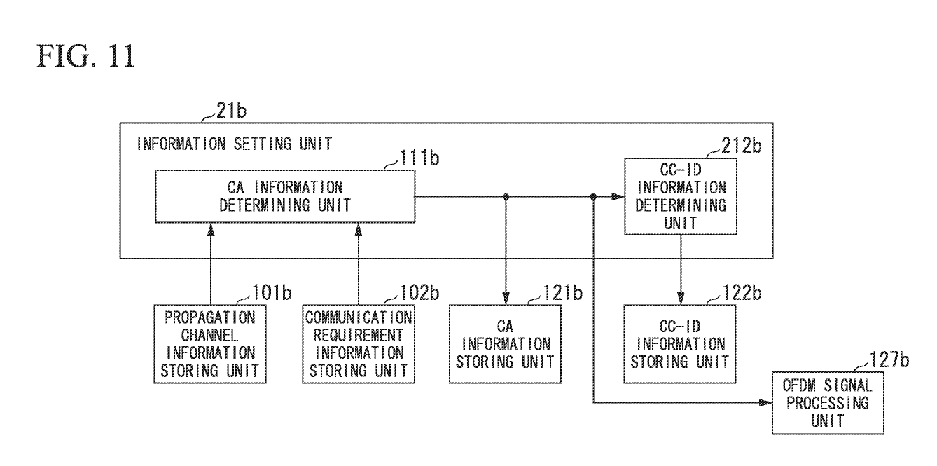

FIG. 11 is a schematic block diagram illustrating a configuration of the information setting unit 21b of the base station apparatus 1b in accordance with a modified example of this embodiment. When the information setting unit 21b (FIG. 11) is compared to the information setting unit 11b (FIG. 7), the CC-ID information determining unit 212b is different. However, a function provided in another configuration (CA information determining unit 111b) is the same as in the above-described embodiment. Description of the same configuration as in the embodiment is omitted.

The CC-ID information determining unit 212b generates CIF size information for every terminal apparatus 1a and a CC-ID list for every monitoring CC of the terminal apparatus 1a based on CA information input from the CA information determining unit 111b. The CC-ID information determining unit 212b outputs the CC-ID information including the determined CIF size and the generated CC-ID list to the CC-ID information storing unit 122b.

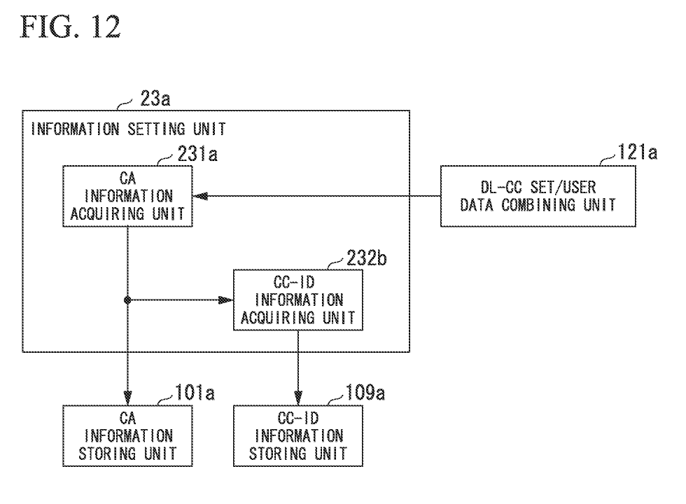

FIG. 12 is a schematic block diagram illustrating a configuration of the information setting unit 23a of the terminal apparatus 1a in accordance with this modified example. In FIG. 12, the information setting unit 23a includes a CA information acquiring unit 231a and a CC-ID information determining unit 232a.

The CA information acquiring unit 231a acquires CA information from user data input from the DL-CC set/user data combining unit 121a, and outputs the acquired CA information to the CA information storing unit 101a and the CC-ID information determining unit 232a.

The CC-ID information determining unit 232a generates CIF size information and a CC-ID list for every monitoring CC based on the CA information input from the CA information acquiring unit 231a. Here, the CC-ID information determining unit 232a generates the CIF size information and the CC-ID list for every monitoring CC by performing the same process as in the CC-ID information determining unit 212b.

As described above, according to this modified example, the base station apparatus 1b determines the CC-ID list according to a predetermined rule based on the CA information, and transmits the CA information. The terminal apparatus 1a determines the CC-ID list according to the same rule as in the base station apparatus 1b based on the CA information received from the base station apparatus 1b. Thereby, in this modified example, DL communication can be performed using the same CC-ID list between the base station apparatus 1b and the terminal apparatus 1a even when a notification of the CC-ID list is not provided, and an overhead for providing the notification of the CC-ID list can be reduced.

A computer may implement some elements of the terminal apparatus 1a and the base station apparatus 1b in the above-described embodiment, for example, the CA information storing unit 101a, the receiving unit 103a, the OFDM signal processing unit 104a, the received data storing unit 105a, the PCFICH information acquiring unit 106a, the PCFICH information storing unit 107a, the monitoring set extracting unit 108a, the CC-ID information storing unit 109a, the DL-CC set/user data combining unit 121a, the application unit 122a, the DCI format acquiring unit 111a, the resource information acquiring unit 112a, the user data acquiring unit 113a, the monitoring CC/user data combining unit 114a, the CIF acquiring unit 1121a, the frequency information acquiring unit 1122a, the mapping information acquiring unit 1123a, the propagation channel information storing unit 101b, the communication requirement information storing unit 102b, the CA information storing unit 121b, the CC-ID information storing unit 122b, the receiving unit 123b, the user data storing unit 124b, the mapping determining unit 125b, the resource information generating unit 126b, the OFDM signal processing unit 127b, the transmitting unit 128b, the CA information determining unit 111b, the CC-ID information setting unit 112b and 212b, the CA information acquiring units 131a and 231a, the CC-ID information acquiring unit 132a, and the CC-ID information determining unit 232a. In this case, the functions may be implemented by recording a program for implementing the functions on a computer-readable recording medium and causing a computer system to read and execute the program recorded on the recording medium. The “computer system” used herein is a computer system embedded in the terminal apparatus 1a and the base station apparatus 1b, and includes an operating system (OS) and/or hardware such as peripheral devices. In addition, the “computer-readable recording medium” refers to a storage apparatus such as a flexible disk, a magneto-optical disc, a read only memory (ROM), a portable medium such as a compact disc-ROM (CD-ROM), or a hard disk embedded in the computer system. Further, the “computer-readable recording medium” may include a medium for temporarily and dynamically storing programs, like a communication line when a program is transmitted via a network such as the Internet or a communication line such as a telephone line, and a medium for storing programs for a predetermined time, like a volatile memory inside a computer system including a server and a client in that case. The program may be a program for implementing some of the above-described functions. Alternatively, the program may be a program capable of realizing the above-described functions through a combination with a program previously stored in a computer system.

In addition, all or part of the terminal apparatus 1a and the base station apparatus 1b in the above-described embodiment may be implemented as large scale integration (LSI), which is a typical integrated circuit. Each functional block of the terminal apparatus 1a and the base station apparatus 1b may be implemented by a separated chip, and all or part may be integrated and implemented by a chip. In addition, a technique of an integrated circuit may be implemented by a dedicated circuit or a general-purpose processor as well as LSI. In addition, when technology of an integrated circuit, which is a substitute for LSI, appears with the development of semiconductor technology, an integrated circuit by the above-described technology can be used.

Although the embodiment of the present invention has been described above in detail with reference to the drawings, specific configurations are not limited to the above-described embodiment, and various design changes can be made without departing from the spirit and scope of the present invention.

### INDUSTRIAL APPLICABILITY

The present invention can be used in a mobile communication system in which a portable telephone apparatus is designated as a terminal apparatus.

### REFERENCE SYMBOLS

1a: Terminal apparatus
101a: CA information storing unit
102a: Antenna
103a: Receiving unit
104a: OFDM signal processing unit
105a: Received data storing unit
106a: PCFICH information acquiring unit
107a: PCFICH information storing unit
108a: Monitoring set extracting unit
109a: CC-ID information storing unit
11a-1, 11a-2: Data processing unit
121a: DL-CC set/user data combining unit
122a: Application unit
13a, 23a: Information setting unit
111a: DCI format acquiring unit
112a: Resource information acquiring unit
113a: User data acquiring unit
114a: Monitoring CC/user data combining unit
1121a: CIF acquiring unit
1122a: Frequency information acquiring unit
1123a: Mapping information acquiring unit
1b: Base station apparatus
101b: Propagation channel information storing unit
102b: Communication requirement information storing unit
11b, 21b: Information setting unit
121b: CA information storing unit
122b: CC-ID information storing unit
123b: Receiving unit
124b: User data storing unit
125b: Mapping determining unit
126b: Resource information generating unit
127b: OFDM signal processing unit
128b: Transmitting unit
129b: Antenna
111b: CA information determining unit
112b, 212b: CC-ID information determining unit
131a, 231a: CA information acquiring unit
132a: CC-ID information acquiring unit
232a: CC-ID information determining unit

1. A communication system comprising a first communication apparatus and a second communication apparatus that communicates with the first communication apparatus using a plurality of frequency bands, wherein:
the first communication apparatus designates a frequency band indicated by control information to be arranged in the frequency band using a frequency band identifier based on correspondence information in which the frequency band identifier and the frequency band are associated among different correspondence information for every frequency band in which a signal of the control information is arranged, and
the second communication apparatus selects a frequency band indicated by control information arranged in the frequency band using a frequency band identifier based on correspondence information in which the frequency band identifier and the frequency band are associated among different correspondence information for every frequency band in which a signal of the control information is arranged.

2. The communication system according to claim 1, wherein:
the first communication apparatus designates a frequency band in which information to be controlled by the control information is arranged, and
the second communication apparatus selects a frequency band in which information to be controlled by the control information is arranged.

3. The communication system according to claim 2, wherein:
the first communication apparatus does not transmit the frequency band identifier indicating the frequency band in which the information to be controlled by the control information is arranged, and
the second communication apparatus selects a frequency band in which the control information is arranged as the frequency band in which the information to be controlled by the control information is arranged in case that there is no frequency band identifier.

4. The communication system according to claim 1, wherein:
the first communication apparatus determines and transmits the correspondence information, and
the second communication apparatus selects the frequency band indicated by the control information arranged in the frequency band using the frequency band identifier based on the correspondence information received from the first communication apparatus.

5. The communication system according to claim 4, wherein:
the second communication apparatus transmits a reception completion notification indicating that the correspondence information has been received from the first communication apparatus,
the first communication apparatus transmits a reception acknowledgement notification indicating that the reception completion notification has been received from the second communication apparatus, and designates the frequency band indicated by the control information to be arranged in the frequency band using the correspondence information after a predetermined period has elapsed from the transmission of the reception acknowledgement notification, and
the second communication apparatus receives the reception acknowledgement notification from the first communication apparatus, and selects the frequency band indicated by the control information to be arranged in the frequency band using the correspondence information after a predetermined period has elapsed from the reception.

6. The communication system according to claim 1, wherein:
the first communication apparatus determines the correspondence information according to a predetermined rule based on frequency band information indicating the frequency band and transmits the frequency band information, and
the second communication apparatus determines the correspondence information according to the rule based on the frequency band information received from the first communication apparatus.

7. The communication system according to claim 6, wherein:
the second communication apparatus transmits a reception completion notification indicating that the frequency band information has been received from the first communication apparatus,
the first communication apparatus transmits a reception acknowledgement notification indicating that the reception completion notification has been received from the second communication apparatus, and designates the frequency band indicated by the control information to be arranged in the frequency band using a determined frequency band identifier after a predetermined period has elapsed from the transmission, and
the second communication apparatus receives the reception acknowledgement notification from the first communication apparatus, and selects the frequency band indicated by the control information to be arranged in the frequency band using the determined frequency band identifier after a predetermined period has elapsed from the reception.

8. The communication system according to claim 1, wherein:
the first communication apparatus transmits the control information including the frequency band identifier, and
the second communication apparatus extracts the frequency band identifier from the control information received from the first communication apparatus, and selects the frequency band indicated by the control information arranged in the frequency band using the extracted frequency band identifier.

9. A communication apparatus, which communicates with another communication apparatus using a plurality of frequency bands,
wherein a frequency band indicated by control information to be arranged in the frequency band using a frequency band identifier is designated based on correspondence information in which the frequency band identifier and the frequency band are associated among different correspondence information for every frequency band in which a signal of the control information is arranged.

10. A communication apparatus, which communicates with another communication apparatus using a plurality of frequency bands,
wherein a frequency band indicated by control information arranged in the frequency band using a frequency band identifier is selected based on correspondence information in which the frequency band identifier and the frequency band are associated among different correspondence information for every frequency band in which a signal of the control information is arranged.

11. A communication control method for use in a first communication apparatus, which communicates with a second communication apparatus using a plurality of frequency bands, the communication control method comprising:
designating, by the second communication apparatus, a frequency band indicated by control information to be arranged in the frequency band using a frequency band identifier based on correspondence information in which the frequency band identifier and the frequency band are associated among different correspondence information for every frequency band in which a signal of the control information is arranged.

12. A communication control method for use in a second communication apparatus, which communicates with a first communication apparatus using a plurality of frequency bands, the communication control method comprising:
selecting, by the first communication apparatus, a frequency band indicated by control information arranged in the frequency band using a frequency band identifier based on correspondence information in which the frequency band identifier and the frequency band are associated among different correspondence information for every frequency band in which a signal of the control information is arranged.

13. A communication control program product for causing a computer of a first communication apparatus, which communicates with a second communication apparatus using a plurality of frequency bands, the communication control program executing:
designating a frequency band indicated by control information to be arranged in the frequency band using a frequency band identifier based on correspondence information in which the frequency band identifier and the frequency band are associated among different correspondence information for every frequency band in which a signal of the control information is arranged.

14. A communication control program product for causing a computer of a second communication apparatus, which communicates with a first communication apparatus using a plurality of frequency bands, the communication control program executing:
selecting a frequency band indicated by control information arranged in the frequency band using a frequency band identifier based on correspondence information in which the frequency band identifier and the frequency band are associated among different correspondence information for every frequency band in which a signal of the control information is arranged.

15. The communication system according to claim 2, wherein:
the first communication apparatus determines and transmits the correspondence information, and
the second communication apparatus selects the frequency band indicated by the control information arranged in the frequency band using the frequency band identifier based on the correspondence information received from the first communication apparatus.

16. The communication system according to claim 3, wherein:
the first communication apparatus determines and transmits the correspondence information, and
the second communication apparatus selects the frequency band indicated by the control information arranged in the frequency band using the frequency band identifier based on the correspondence information received from the first communication apparatus.

17. The communication system according to claim 2, wherein:
the first communication apparatus determines the correspondence information according to a predetermined rule based on frequency band information indicating the frequency band and transmits the frequency band information, and
the second communication apparatus determines the correspondence information according to the rule based on the frequency band information received from the first communication apparatus.

18. The communication system according to claim 3, wherein:
the first communication apparatus determines the correspondence information according to a predetermined rule based on frequency band information indicating the frequency band and transmits the frequency band information, and
the second communication apparatus determines the correspondence information according to the rule based on the frequency band information received from the first communication apparatus.

19. The communication system according to claim 2, wherein:
the first communication apparatus transmits the control information including the frequency band identifier, and
the second communication apparatus extracts the frequency band identifier from the control information received from the first communication apparatus, and selects the frequency band indicated by the control information arranged in the frequency band using the extracted frequency band identifier.

20. The communication system according to claim 3, wherein:
the first communication apparatus transmits the control information including the frequency band identifier, and
the second communication apparatus extracts the frequency band identifier from the control information received from the first communication apparatus, and selects the frequency band indicated by the control information arranged in the frequency band using the extracted frequency band identifier.
